(19) United States
(12) Patent Application Publication
(10) Pub. No.: US 2009/0238941 A1
(43) Pub. Date: Sep. 24, 2009

(54) PREBIOTIC CHOCOLATE AND METHOD FOR PRODUCING THE SAME

(75) Inventor: Norhayati Hussain, Selangor (MY)

Correspondence Address: MERCHANT & GOULD PC, P.O. BOX 2903, MINNEAPOLIS, MN, 55402-0903, US

(73) Assignee: LEMBAGA KOKO MALAYSIA, Kota Kinabalu, Sabah (MY)

(21) Appl. No.: 12/300,297

(22) PCT Filed: Apr. 19, 2007
(86) PCT No.: PCT/MY2007/000023

§ 371 Date: Nov. 10, 2008

(30) Foreign Application Priority Data
Jul. 13, 2006 (MY) PI 20063327

(51) Int. Cl. A23G 1/46

(52) U.S. Cl. 426/584

(57) ABSTRACT

This invention describes formulations for prebiotic milk and dark chocolates comprising of admixture of cocoa components, milk components, emulsifier, a flavor component and sweetener wherein said sweetener comprising of inulin and isolmalt. Also disclosed herein are the methods for producing said prebiotic milk and dark chocolates.

### FIELD OF INVENTION

This invention relates to formulation for prebiotic milk and dark chocolates. Also disclosed herein are the methods for producing said prebiotic milk and dark chocolates.

### TECHNOLOGICAL BACKGROUND

Prebiotic is a nondigestible food ingredient which is not hydrolysed nor absorbed in the upper part of the gastrointestinal tract. It beneficially affects the host by selectively stimulating the growth and/or the activity of one or limited number of bacteria in the colon and thus improves the host health (Gibson & Roberfroid, 1995).

Inulin, which is known as dietary fibers by definition and by nutritional properties (Kolbye et al., 1992) is also classified as prebiotics. Research has shown that daily ingestion of 15 g of inulin, resulted in a significant increase in the beneficial bifidobacteria in the colon (bifidogenic effect), while at the same time significantly reducing the presence of less desirable bacteria such as Clostridia (Roberfroid, 1993 & Young, 1997).

The fermentability and bifidogenic effects of inulin have been confirmed with in vitro (Wang et. al., 1993) and in vivo studies (Campbell et. al, 1997). Davidson et al. (1998) have reported data in slightly hypercholesterolemic human volunteers indicated that inulin (18 g/day for 3 weeks) may lower both total and LDL serum cholesterol. Inulin has been known to regulate gastrointestinal transit time and stool weight and enhance the adsorption of calcium (Roberfloid, 1993).

Inulin is a complex carbohydrate that belongs to a class compound known as fructans. Industrially, inulin is produced from the flaked chicory root by extraction at high temperature followed by an ion exchange process (Dysseleer & Hoffem, 1995). It is also classified legally as food ingredients and not as food additives by the EU Directive EC 95/2. Inulin has a calorie value similar with that of soluble dietary fibre, i.e. 1.0 kcal/g (4.2 kJ/g), as compared to sucrose which has an energetic value of 4 kcal/g. (Reddy, 1998)

Thus, the use of inulin in food products has become firmly established due to its beneficial effects at the nutrition and therapeutic levels. There are various healthy products which have been known to be incorporated with inulin such as infant milk powder, desserts, candies, etc. Inulin has also been included in some chocolate formulations mainly for the purpose of substitution of sucrose. Said chocolate formulations are for the intention to reduce the calorie content of said chocolate and having little or no effect as prebiotic.

### SUMMARY OF INVENTION

It is therefore an object of the present invention to provide for an effective formulation of prebiotic chocolates. The said chocolate formulation according to the present invention is suitable for either milk or dark prebiotic chocolate.

Accordingly, there is provided a prebiotic chocolate composition comprising of admixture of cocoa components, milk components, emulsifier, a flavor component and sweetener wherein said sweetener comprising of 19 to 34 wt % inulin and 5 to 8 wt % isomalt. Said prebiotic chocolate formulation is suitable for either milk or dark chocolate.

Another object of the invention is to provide for a method for producing said prebiotic milk chocolate wherein said method comprising the steps of:
(a) mixing cocoa liquor, a part of cocoa butter and milk components to form a paste;
(b) refining said mixture in (a) to particle size<45 μm;
(c) conching said refined mixture in (b) for 4 to 7 hr;
(d) mixing inulin, isomalt and the balance part of cocoa butter in another mixer to form a paste;
(e) refining said mixture in (d) to particle size<45 μm;
(f) combining said refined mixture in step (e) with said mixture in step (c) and conching said combined mixture for 1 hr;
(g) adding emulsifier and flavor component to said mixture in (f) and conching said mixture further for 2-5 hrs;
(h) tempering said mixture in (g) to 27-28° C.;
(i) pouring said chocolate mixture into desired mould;
(j) chilling said chocolate mixture at a temperature between 16 to 20° C. to set; and,
(k) demoulding said prebiotic chocolate.

Yet another object of the invention is to provide for a method for producing said prebiotic dark chocolate wherein said method comprising the steps of:
(a) mixing cocoa liquor, a part of cocoa butter and milk components to form a paste and conch said mixture for 4 to 7 hr;
(b) mixing inulin, isomalt and the balance part of cocoa butter in another mixer to form a paste;
(c) refining said mixture in (b) to particle size<45 μm;
(d) combining said refined mixture in step (c) with said mixture in step (a) and conching said combined mixture for 1 hr;
(e) adding emulsifier and flavor component to said mixture in (d) and conching said mixture further for 2-5 hrs;
(f) tempering said conched mixture in step (e) to 29-30° C.;
(g) pouring said chocolate mixture into desired mould;
(h) chilling said chocolate mixture at a temperature between 16 to 20° C. to set; and,
(i) demoulding said prebiotic chocolate.

In order that the present invention may be readily understood and be put into practical effect, the present invention will be described with reference to preferred embodiments by way of examples in the following Detailed Description.

### DETAILED DESCRIPTION OF THE INVENTION

Milk and dark chocolate formulations generally comprise of admixture of cocoa components, milk components, and sweetener. Said cocoa components comprise cocoa butter and cocoa powder, said milk component comprises milk powder and butter fat and said sweetener component comprises a sucrose, sugar alcohol or carbohydrates such as polydextrose and oligofructose. Emulsifiers such as lecithin and a flavor component such as aspartame or acesulphame K are commonly added to improve the texture and to increase the sweetness of the chocolate, respectively.

According to the first object of the present invention, there is provided a prebiotic chocolate composition comprising of admixture of cocoa components, milk components, emulsifier, a flavor component and sweetener wherein said sweetener comprises 19 to 34 wt % inulin and 5 to 8 wt % isomalt. Thus, the sweetener component according to the present invention does not utilize sucrose or sugar. Instead, the present formulations substitute sucrose or sugar with 19 to 34 wt % inulin and 5 to 8 wt % isomalt. It has been surprisingly found that such amount of inulin and isomalt have effectively contributed to the prebiotic characteristic of said milk and dark chocolate without significantly adversely affecting its texture and taste.

The recipes in Example 1 and Example 2 below illustrate the use of inulin and isomalt in accordance with the present invention in the preparation of prebiotic milk and dark chocolate respectively. In both Examples, the source of inulin (Fruitafit® IQ) with an average degree of polymerization=10, is supplied by Gulf Chemical Sdn. Bhd.

### Experimental Design for Prebiotic Milk and Dark Chocolate Formulation

Design of experiment is based on Response Surface Methodology (Box Behnken) with 2 types of chocolate (milk and dark chocolate), 2 variables (inulin & isomalt) and 3 replications at centre point. Inulin and isomalt were incorporated into milk and dark chocolate with certain proportion to replace sucrose while other ingredients in the recipe remain the same. Proportion of inulin used was selected to fit the consumption recommendation for stimulation of Bifidobacteria in colon which usually required an intake of at least 5 g inulin per day. The prebiotic chocolates were developed based on standard milk chocolate and dark chocolate recipe from Orafti Company. The standards (without inulin and isomalt) were used as a control. The production was carried out based on existing Malaysian Cocoa Board method using lab scale equipment with 1 kg capacity. Three ingredients, inulin, isomalt and aspartame were used in the test chocolate. There were several formulations prepared for each milk and dark chocolate, excluding control or standard chocolate. These formulations contain different proportion of inulin and isomalt within the range stated in test chocolate.

### Example 1

Milk chocolate standard recipeTest Milk Chocolate

| Ingredients: | quantity (kg) | % (w/w) | % (w/w) |
|---|---|---|---|
| Raftiline HP/Inulin* | 0 | | 19 to 34% |
| Maltitol/Isomalt* | 0 | | 5 to 8% |
| Sucrose | 17.60 | 44.00 | 0% |
| Skim milk powder | 0.59 | 1.48 | as per standard |
| Full cream powder | 8.40 | 21.00 | ″ |
| Cocoa liquor | 4.60 | 11.50 | ″ |
| Cocoa butter | 8.60 | 21.50 | ″ |
| Lecithin | 0.20 | 0.50 | ″ |
| Vanilla/Aspartame* | 0.008 | 0.02 | ″ |
| Total | 40.00 | 100.00 | 100 |

### Example 2

Dark chocolate standard recipeTest Dark Chocolate

| Ingredients: | quantity (kg) | % (w/w) | % (w/w) |
|---|---|---|---|
| Raftiline HP/Inulin* | 0 | | 19 to 34% |
| Maltitol/Isomalt* | 0 | | 5 to 8% |
| Sucrose | 17.60 | 44.00 | 0% |
| Skim milk powder | 1.60 | 4.00 | as per standard |
| Full cream powder | 0.59 | 1.48 | ″ |
| Cocoa liquor | 16.80 | 42.00 | ″ |
| Cocoa butter | 3.20 | 8.00 | ″ |
| Lecithin | 0.20 | 0.50 | ″ |
| Vanilla/Aspartame* | 0.008 | 0.02 | ″ |
| Total | 40.00 | 100.00 | 100 |

According to the second object of the invention, there is provided a method for producing prebiotic milk chocolate comprising the steps of:
(a) mixing cocoa liquor, a part of cocoa butter and milk components to form a paste;
(b) refining said mixture in (a) to particle size<45 μm
(c) conching said refined mixture in (b) for 4 to 7 hr;
(d) mixing inulin, isomalt and the balance part of cocoa butter in another mixer to form a paste;
(e) refining said mixture in (d) to particle size<45 μm;
(f) combining said refined mixture in step (e) with said mixture in step (c) and conching said combined mixture for 1 hr;
(g) adding emulsifier and flavor component to said mixture in (f) and conching said mixture further for 2-5 hrs;
(h) tempering said mixture in (g) to 27-28° C.;
(i) pouring said chocolate mixture into desired mould;
(j) chilling said chocolate mixture at a temperature between 16 to 20° C. to set; and,
(k) demoulding said prebiotic chocolate.

The above process will be described in detail below.

### Mixture 1

Mix cocoa liquor followed by full cream milk powder, skim milk powder and small portion of cocoa butter to make a paste. The mixing is done in a concher for 5 to 10 minutes at 38° C. to 45° C. afterwhich the mixture is refined to particle size up to a fineness of <45 μm. Refining may be done on a 3-roll mill refiner (lab scale). Generally, industries will use 5-roll mill refiner which gives better particle size. After refining, the mixture of cocoa liquor, full cream milk powder, skim milk powder and small portion of cocoa butter is conched for 4 to 7 hours at 38° C. to 45° C.

### Mixture 2

Mix inulin, isomalt and remaining of cocoa butter together as a paste (depend on formulation) in another mixer and refine said mixture to particle size up to a fineness of <45 μm.

Add this Mixture 2 to Mixture 1 and conch the combined mixture for one hour. Finally, add lecithin and aspartame to the combined mixture and conch the mixture further for 2-5 hrs.

### Tempering

Pour out chocolate (¾) on marble slab and temper to temperature 26-27° C. and mix it back to the remaining chocolate. Let the temperature of the mixture raises to 27-28° C. Pour chocolate into mould and let it cool in a chiller at 16-20° C. till it sets. Finally, demould the chocolate.

### Product Characteristics (Prebiotic Milk Chocolate):

| | Standard Recipe | Test Recipe |
|---|---|---|
| Dry substance | 99.5% | 99.5% |
| Inulin | — | 19.0-34.0% |
| Isomalt | — | 5.0-8.0% |
| Fat | 33.8% | 32.7-39.4% |

According to the third object of the invention, there is provided a method for producing prebiotic dark chocolate comprising the steps of:
(a) mixing cocoa liquor, a part of cocoa butter and milk components to form a paste and conch said mixture for 4 to 7 hr;
(b) mixing inulin, isomalt and the balance part of cocoa butter in another mixer to form a paste;
(c) refining said mixture in (b) to particle size<45 μm;
(d) combining said refined mixture in step (c) with said mixture in step (a) and conching said combined mixture for 1 hr;
(e) adding emulsifier and flavor component to said mixture in (d) and conching said mixture further for 2-5 hrs;
(f) tempering said conched mixture in step (e) to 29-30° C.;
(g) pouring said chocolate mixture into desired mould;
(h) chilling said chocolate mixture at a temperature between 16 to 20° C. to set; and,
(i) demoulding said prebiotic chocolate.

The above process will be described in detail below.

### Mixture A

Mix cocoa liquor, a part of cocoa butter and milk components in a concher to form a paste afterwhich the mixture is conched for 4 to 7 hours at 38° C. to 45° C. (Milk powder used in prebiotic dark chocolate formulation is much lesser than in milk chocolate thus refining process for this mixture is not required).

### Mixture B

Mix inulin, isomalt and remaining of cocoa butter together as a paste (depend on formulation) in another mixer and refined said mixture to particle size up to a fineness of <45 μm. Refining may be done on a 3-roll mill refiner (lab scale). Generally, industries will use 5 roll mill refiner which gives better particle size.

Add this Mixture B to Mixture A and conch the combined mixture for one hour. Finally, add lecithin and aspartame to the combined mixture and conch the mixture further for 2-5 hrs.

### Tempering

Pour out chocolate (¾) on marble slab and temper to temperature 28-29° C. and mix it back to the remaining chocolate. Let the temperature of the mixture raises to 29-30° C. Pour chocolate into mould and let it cool in a chiller at 16-20° C. till it sets (a ½ hour). Finally, demould the chocolate.

### Product Characteristics (Prebiotic Dark Chocolate):

| | Standard Recipe | Test Recipe |
|---|---|---|
| Dry substance | 99.5% | 99.5% |
| Inulin | — | 19.0-34.0% |
| Isomalt | — | 5.0-8.0% |
| Fat | 29.4% | 29.4-35.4% |

Generally, the overall conching process in the preparation of prebiotic milk and dark chocolate mixtures in accordance with the invention takes about 10 hrs before the tempering process takes place. However, the overall conching process between 8 to 10 hr is preferred.

It is to be understood by persons skilled in the art that the physical embodiments described herein only exemplify the invention which may be embodied in other specific structure. The scope of the invention is defined in the claims appended thereupon.

1. A prebiotic chocolate composition comprising of admixture of cocoa components, milk components, emulsifier, a flavor component and sweetener wherein said sweetener comprising of 19 to 34 wt % inulin and 5 to 8 wt % isomalt.

2. A prebiotic chocolate composition according to claim 1 wherein said prebiotic chocolate is milk chocolate.

3. A prebiotic chocolate composition according to claim 1 wherein said prebiotic chocolate is dark chocolate.

4. A method for preparing prebiotic chocolate according to claim 2 comprising the steps of:
(a) mixing cocoa liquor, a part of cocoa butter and milk components to form a paste;
(b) refining said mixture in (a) to particle size<45 μm;
(c) conching said refined mixture in (b) for 4 to 7 hr;
(d) mixing inulin, isomalt and the balance part of cocoa butter in another mixer to form a paste;
(e) refining said mixture in (d) to particle size<45 μm;
(f) combining said refined mixture in step (e) with said mixture in step
(c) and conching said combined mixture for 1 hr;
(g) adding emulsifier and flavor component to said mixture in (f) and conching said mixture further for 2-5 hrs;
(h) tempering said mixture in (g) to 27-28° C.;
(i) pouring said chocolate mixture into desired mould;
(j) chilling said chocolate mixture at a temperature between 16 to 20° C. to set; and,
(k) demoulding said prebiotic chocolate.

5. A method according to claim 4 wherein said chocolate mixture is conched for a total of 8 to 10 hr.

6. A method according to claim 4 wherein said chocolate mixture is conched at a temperature of 38 to 45° C.

7. A method for preparing prebiotic chocolate according to claim 3 comprising the steps of:
(a) mixing cocoa liquor, a part of cocoa butter and milk components to form a paste and conch said mixture for 4 to 7 hr;
(b) mixing inulin, isomalt and the balance part of cocoa butter in another mixer to form a paste;
(c) refining said mixture in (b) to particle size<45 μm;
(d) combining said refined mixture in step (c) with said mixture in step (a) and conching said combined mixture for 1 hr;
(e) adding emulsifier and flavor component to said mixture in (d) and conching said mixture further for 2-5 hrs;
(f) tempering said conched mixture in step (e) to 29-30° C.;
(g) pouring said chocolate mixture into desired mould;
(h) chilling said chocolate mixture at a temperature between 16 to 20° C. to set; and,
(i) demoulding said prebiotic chocolate.

8. A method according to claim 7 wherein said chocolate mixture is conched for a total of 8 to 10 hr.

9. A method according to claim 7 wherein said chocolate mixture is conched at a temperature of 38 to 45° C.
